(19) United States
(12) Patent Application Publication
(10) Pub. No.: US 2026/0077954 A1
(43) Pub. Date: Mar. 19, 2026

(54) IMPACT BED FOR CONVEYOR BELT

(71) Applicant: Tru-Trac Rollers (Pty) Ltd, Centurion (ZA)

(72) Inventor: Hendrik Stephanus Pretorius, Centurion (ZA)

(73) Assignee: Tru-Trac Rollers (Pty) Ltd, Centurion (ZA)

(21) Appl. No.: 19/109,058

(22) PCT Filed: Sep. 5, 2023
(86) PCT No.: PCT/IB2023/058762

§ 371 Date: Mar. 5, 2025

(30) Foreign Application Priority Data
Sep. 5, 2022 (AU) 2022902562

(51) Int. Cl. B65G 15/62

(52) U.S. Cl. CPC B65G 15/62; B65G 2207/28

(57) ABSTRACT

An impact bed (10) for a conveyor belt installation, which impact bed (10) is adapted to be mounted or installed below the belt of the installation in a location where material is received onto the belt. The impact bed (10) comprises a central impact section (20) and first and second side impact sections (22) which are pivotably supported relative to opposite sides of the central impact section (20) such that an angle (24) of each side impact section (22) relative to the central impact section (22) is adjustable. At least first and second adjustable support mechanisms (34) are associated with the first and second side impact sections (22) respectively. Each adjustable support mechanism (34) configured for adjusting the angle (24) of the respective side impact section (22) and operatively to retain said side impact section (22) at a predetermined angle.

### BACKGROUND TO THE INVENTION

This invention relates to an impact bed. More particularly, the present invention relates to an impact bed for a conveyor belt installation, which impact bed is adapted to be mounted below the belt of the conveyor installation in a location where material is received onto the belt via a feed hopper or chute.

An impact bed is typically designed to be positioned or located below a trough shaped conveyor belt in a location where the belt is loaded with material from a chute located above the belt. Depending on the installation, the material can fall some distance before landing on the belt. Heavy and abrasive material, such as rocks and ore, would damage the belt if the belt were unsupported at the impact location. Impact beds are therefore designed to provide that support and thereby limit the amount of damage or abrasion caused to the belt by the impact of the material. Typically, impact beds have the same shape as the conveyor belt, that is, for trough belts, the impact bed has a horizontal middle section, and sloping side sections which mirror the shape of the belt. Impact beds typically comprise a robust frame on which impact slats or pads, aligned with a travel direction of belt, are mounted. Each impact slat or pad typically comprises a steel joist to which a resilient rib of elastomeric material is mounted. The ribs are designed to flex under impact in order to absorb loads caused as the falling material strikes the belt.

To function properly and therefore prevent or at least inhibit or limit damage to the belt, the impact slats or pads ideally need to be mounted in contact with the underside of the belt. It follows that the angles of the sloping side sections need to be the same as the troughing angle of the sloping side sections of the belt. In practice, the sloping side sections of the belts of different conveyor belt installations differ. Proper installation of the impact bed therefore calls for the impact bed to be manufactured to match the troughing specific angle. Typically, the angle varies between about 15 degrees and about 45 degrees to the horizontal. Thus, manufacturers of impact beds typically manufacture the frames once they have received an order and after the troughing angle of the belt has been determined. This complicates the order and manufacturing process and negates the possibility of maintaining standardised stock or spare items.

A need therefore exists for an impact bed that can be used over a wide range of belts with different troughing angles.

It is accordingly an object of the invention to provide an impact bed that will, at least partially, address the above disadvantages.

It is also an object of the invention to provide an impact bed which will be a useful alternative to existing impact beds.

### SUMMARY OF THE INVENTION

In accordance with a first aspect of the invention there is provided an impact bed comprising:
a central impact section and a first and second side impact sections pivotably supported relative to opposite sides of the central impact section such that an angle of each side impact section relative to the central impact section is adjustable;
at least a first and second adjustable support mechanism associated with the first and second side impact sections respectively, each adjustable support mechanism configured for adjusting the angle of the respective side impact section and operatively to retain said side impact section at a predetermined angle.

Each adjustable support mechanism may comprise a support arm which may be pivotably fixed to a base. The adjustable support mechanism may furthermore comprise an adjustment mechanism received between the support arm and the base.

Furthermore, each side impact section may be fixed relative to the support arm of the respective adjustable support mechanism associated with it.

The adjustment mechanism may comprise a pivotably interconnected upper and lower support strut configured as a scissor link. Opposite end portions of the scissor link (in other words, an upper end portion of the upper strut and a lower end portion of the lower strut) may be pivotably linked or fixed to the support arm and base respectively.

An adjustment rod may extend between the scissor link and either the support arm or the base. The adjustment rod may comprise a threaded rod which may be lockable and/or adjustable relative to the scissor link by way of an adjustment nut. A locknut may further be provided for locking a position of the adjustment nut relative to the adjustment rod.

Typically, the adjustment rod may extend through a bush which may be pivotably supported by the scissor link.

Alternatively, the adjustment mechanism may comprise an adjustment rod which may extend directly between the support arm and the base. The adjustment rod may again be lockable and/or adjustable by way of an adjustment nut.

Further in accordance with the invention, each of the impact sections (in other words, the central impact section and the side impact sections) may comprise one or more impact slat or pad, which may be arranged in a direction parallel with an operative displacement direction of the belt. Alternatively, each of the impact sections (in other words, the central impact section and the side impact sections) may comprise one or more impact bar, impact roller or idler, or impact slider bar.

The impact bed may furthermore comprise a main support frame. The central impact section may be fixed and/or supported directly by the main support frame. Furthermore, the base of each adjustable support mechanism may be fixed relative to the main support frame.

Typically, each side impact section may be associated with two adjustable support mechanisms.

The impact bed may be configured as a loading bed. The central impact section may therefore be configured as a central loading section and the first and second side impact sections may be configured as first and second side loading sections.

### BRIEF DESCRIPTION OF THE DRAWINGS

The invention will now be described in more detail, by way of example only, with reference to the accompanying drawings in which:

FIG. 1 shows a perspective view of an impact bed according to the invention;

FIG. 2 shows a top view of the impact bed shown in FIG. 1;

FIG. 3 shows a front view of the impact bed shown in FIG. 1;

FIG. 4 shows a side view of the impact bed shown in FIG. 1;

FIG. 5 shows a perspective view of an adjustment mechanism forming part of the impact bed shown in FIG. 1;

FIG. 6 shows a side view of the adjustment mechanism shown in FIG. 5;

FIG. 7 shows a perspective view of an impact bed according to a second embodiment of the invention, in which the impact bed is configured as a loading bed comprising idlers and slider bars instead of impact slats; and

FIG. 8 shows a perspective view of an impact bed according to a third embodiment of the invention, in which the impact bed is again configured as a loading bed comprising impact rollers and impact pads.

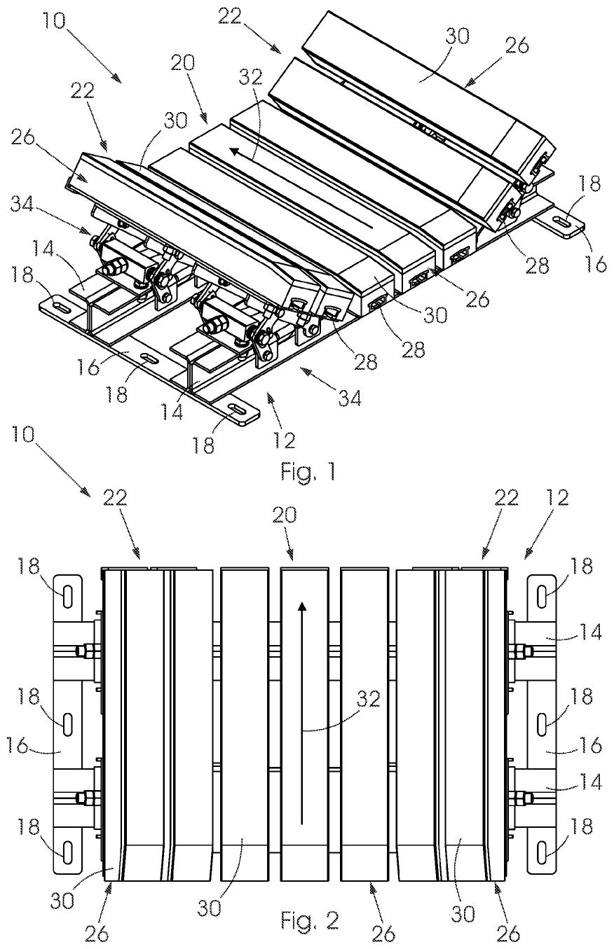

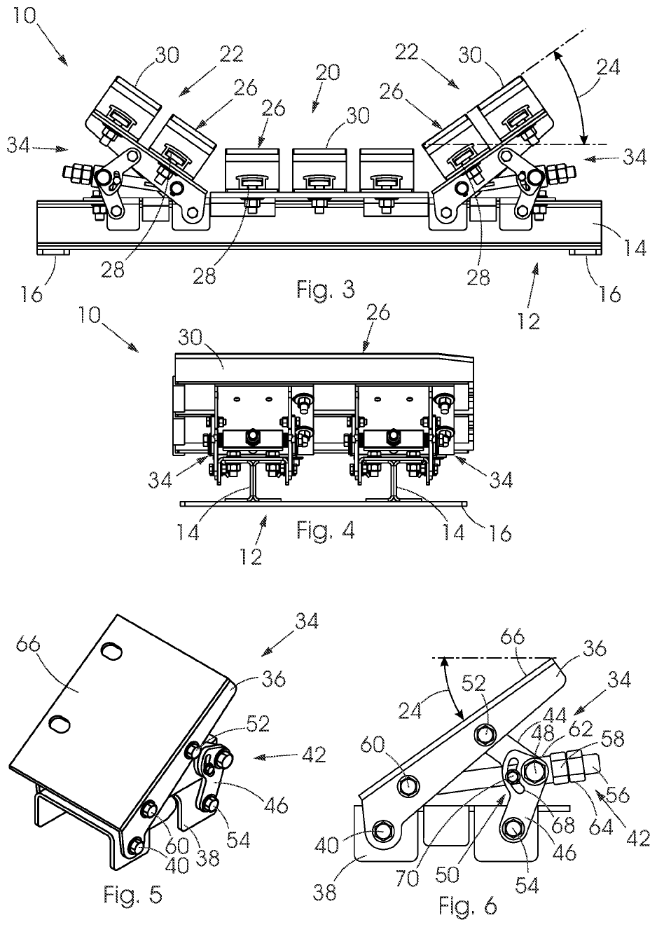

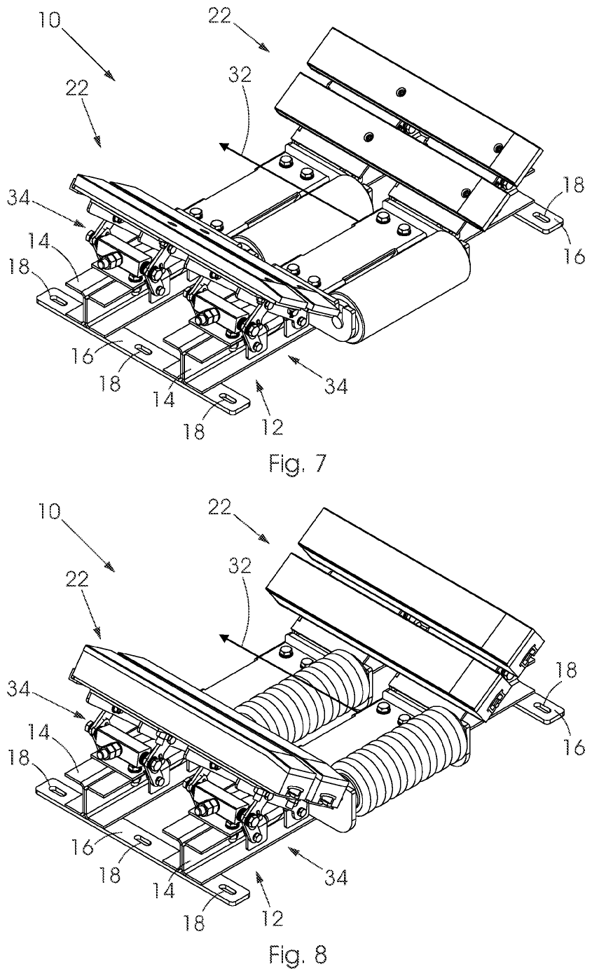

### DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “engaged” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “engaged” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of an impact bed in accordance with the invention is generally indicated by reference numeral 10.

The impact bed comprises a support frame 12 adapted to be mounted to a frame or structure (not shown) of or associated with a conveyor installation (not shown), below a chute or feed hopper (not shown). More particularly, the impact bed 10 is mounted below a belt (not shown) of the conveyor in an area where material is fed via the chute onto the belt. The support frame 12 comprises a pair of spaced apart steel I-beams 14 and a pair of cross bars 16 which hold the I-beams in a rectangular configuration and have mounting holes 18 for mounting the impact bed 10 to the conveyor frame or structure.

The impact bed 10 comprises a central impact section 20 and first and second side impact sections 22. The side impact sections are mirror images of each other and are substantially similar in terms of structural makeup. Any discussion herein pertaining to one of the side impact sections 22 or the side impact sections generally, will be taken to refer to both side impact sections 22.

The side impact sections 22 are pivotably fixed relative to opposite sides of the central impact section 20. In use, the side impact sections 22 are arranged in upward sloping configuration such that a cross-section of the impact bed (defined by the central and side impact sections [20, 22]) mimics the shape of a trough conveyor belt. Each side impact section 22 defines a sloping angle 24 relative to the central impact section 20. The sloping angle 24 is defined as an acute angle between an imaginary extension of an upper surface of the central impact portion, and an upper surface of the respective side impact section 22. Importantly, since the side impact sections 22 are mounted pivotably relative to the central impact section 20, the sloping angle 24 of each side impact section 22 is adjustable, in situ. Therefore, in use, the sloping angles 24 are adjusted to mirror a troughing angle of the belt to provide for close contact between the belt and the impact bed 10.

The central and side impact sections (20, 22) comprise at least one, but typically a number of impact slats or pads 26. Each impact slat or pad 26 comprises a lengthwise extending steel joist 28 and a resilient rib 30 which is received over the steel joist 28 and manufactured from an elastomeric material able to absorb impact loads caused by material falling on the conveyor belt (not shown). The impact slats or pads 26 are aligned with the direction of travel of the belt, indicated by the arrow 32.

In the embodiment shown in the figures the central impact section 20 comprises three impact slats or pads 26, and the side impact sections 22 each comprise two impact slats or pads 26. It will be appreciated that for wider belts the central impact section 20 would have a greater number of impact slats or pads as would the side impact sections 22. Narrower configurations would also be feasible.

The impact slats or pads 26 are generally of know kind and configuration.

The impact bed 10 also comprises at least a first and second adjustable support mechanism 34. Therefore, each side impact section 22 is associated with at least one of the adjustable support mechanisms 34. Typically, however, each side impact section 22 will be associated with two adjustable support mechanisms 34. Again, all of the adjustable support mechanisms 34 are substantially similar, and any discussion in respect of a particular one of the adjustable support mechanisms, or the adjustable support mechanisms in general, will be taken to apply to each adjustable support mechanism 34 individually.

The side impact sections 22 are mounted directly to and therefore are supported by their associated adjustable support mechanisms 34. As discussed more fully below, the adjustable support mechanisms 34 facilitate adjustment of the sloping angles 24. Furthermore, the adjustable support mechanisms 34 are lockable in a predetermined position, such that the side impact sections 22 are operatively locked or retained at a predetermined sloping angle (as mentioned, an angle mirroring the troughing angle of the belt).

A first and preferable embodiment of the adjustable support mechanism 34 is shown in FIGS. 5 and 6. The adjustable support mechanism 34 comprises a support arm 36 and a base 38. The support arm 36 is pivotably fixed to the base 38 by way of a hinge pin 40. An axis of the hinge pin 40 extends substantially parallel to the direction 32. The base 38 is typically mounted to the support frame 12 while the side impact sections are mounted, directly or indirectly to the support arm 36. An angle of the support arm 36 relative to the base 38 is linked or even equal to the sloping angle 24.

An adjustment mechanism 42 extends between the support arm 36 and the base and facilitates both angular adjustment and locking of the support arm 36 relative to the base 40. In the embodiment of FIGS. 5 and 6, the adjustment mechanism 42 includes a first and second (or rather, upper and lower) support strut (44, 46). The upper and lower support struts (44, 46) are pivotably interconnected by way of a link pink 48 and are configured as a scissor link 50. Upper and lower end portions (not referenced) of the scissor link 50 are pivotably connected to the support arm 36 and base 38 respectively by means of an upper and lower link pin (52, 54). The adjustment mechanism 42 also includes an adjustment rod 56, in the form of a threaded rod, with an adjustment nut 58. The adjustment rod extends between the scissor link 50 and either the support arm 36 or the base 38. It will be appreciated that the exact fixing and arrangement of the adjustment rod 56 relative to the scissor link and the support arm 36 or base 38 can take various forms and configurations, provided that the adjustment rod 56 and adjustment nut 58 are capable of facilitating adjustment and locking of the support arm 36 relative to the base 38. This can, for example, be achieved by one end portion of the adjustment rod 56 being pivotably fixed relative to the support arm (typically by means of a pin 60) while an opposite end portion of the adjustment rod 56 is received through a bush 62 pivotably supported by the link pin 48. Here, the adjustment nut 58 bears on or contacts the bush 62, and adjustment of the adjustment nut 58 adjusts a distance between the pin 60 and the link pin 48, thereby adjusting the angle. A locknut 64 may furthermore be provided to lock the position of the adjustment nut 58 securely in place.

Typically, the base 38 may comprise an inverted U-shaped structure and the support arm 36 may comprise two support arms, interconnected by a top plate 66. The top plate 66 provides structural rigidity and integrity to the adjustable support mechanism 34. The side impact section 22 is directly mounted to the top plate 66.

A curved slot 68 with a pin 70 therethrough supports the two struts (44, 46) when pivoting relative to each other and as the angle of the support arm 36 is adjusted.

It is envisaged that the adjustable support mechanism 34 will be such that the angle 24 can be adjusted between about 15 degrees and 45 degrees, although clearly it is possible to have a wider adjustment capability should this prove necessary. In some cases, the impact bed may be configured to allow the side impact sections 22 to pivot flat and inline with the central impact section 20.

It will be appreciated that due the configuration of the adjustable support mechanism 34 according to the embodiment shown in FIGS. 5 and 6, the adjustable support mechanism 34 can easily be adjusted from a side of the impact bed (since the adjustment rod 56 and the adjustment nut 58 face towards the side). The adjustment mechanism 42 is therefore easily accessible after installation of the impact bed 10 as part of a larger conveyor installation.

Installation of the impact bed 10 will be relatively straightforward. An impact bed 10 for a particular width of belt will be selected, irrespective of the troughing angle of the belt. The impact bed 10 will then be installed on the conveyor frame and the slope angles 24 of the two side impact sections 22 adjusted, using the adjustment mechanism 42, so that the impact slats or pads 26 of the side impact sections 22 are brought just in contact with an underside of the sloping sides of the conveyor belt. It will be appreciated that the threaded adjustment rod 56 and adjustment nut 58 and locknut 64 can provide relatively fine adjustment, thus allowing the side impact sections 22 to be positioned correctly against the underside of the belt. Once the side impact sections 22 are at the correct angle, the adjustment nut 58 and locknut 64 is tightened against each other, thereby locking the side impact sections 22 at the predetermined or selected angle.

It will be appreciated that when conventional impact beds (without adjustable support mechanisms and where the side impact sections are at fixed angles relative to the central impact section) have side impact sections which are not at quite the correct angle, the entire impact bed will need to be removed, and replaced with another having the correct angle. This in practice has resulted in considerable waste of time, downtime, costs and materials. In most cases, impact beds had to be custom made according to specific requirements, or side impact sections were simply not ideally close to the belt, resulting in premature damage or failure of the belt. The present invention substantially overcomes these problems. The specific configuration of the impact bed 10, and more particularly, that of the adjustable support mechanisms 34, also allows for very fine adjustments to be made to the sloping angles 34.

It will be appreciated that the above description only provides an example embodiment of the invention and that there may be many variations without departing from the spirit and/or the scope of the invention.

For example, adjustable support mechanisms where the adjustment mechanism simply comprises an adjustment rod extending directly between the support arm and the base could be used. However, it is considered that the embodiment of the adjustable support mechanism 42 as shown in FIGS. 5 and 6 is particularly advantageous due to the simplicity with which adjustments may be effected using simple hand tools, such as a pair of spanners, together with the ability to effect adjustments from the side of the impact bed 10.

Furthermore, in some cases, finer, lighter or less aggressive materials (such as sugar cane, grain and the like) may be transported using the conveyor belt. In such cases, loading of the material onto the belt would not cause high impacts as such. However, the impact bed 10 may still find application in such low or medium impact applications and may provide similar advantages as hereinbefore discussed. Therefore, throughout this disclosure, the term “impact bed” may therefore be considered synonymous with the term “loading bed”. Similarly, the term “impact section” may be considered synonymous with the term “loading section”. In some such cases, the central and/or side impact or loading sections may be associated with idlers or impact rollers or slider bars, instead of impact slats or pads. Various combinations of these may be possible. For example, in some cases, the central impact or loading section may comprise idlers, while the side impact or loading sections may comprise slider bars. The slider bars may be replaced by impact pads, idlers or impact rollers. In another example, the idlers of the central impact or loading section may be replaced by impact rollers. In any of the aforementioned examples, all the impact or loading sections may comprise idlers or impact rollers.

It will be easily understood from the present description that the particular features of the present invention, as generally described and illustrated in the figures, can be arranged and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described one embodiment can be isolated from the other characteristics of this embodiment unless otherwise expressed.

1. An impact bed comprising:
a central impact section and a first and second side impact sections pivotably supported relative to opposite sides of the central impact section such that an angle of each side impact section relative to the central impact section is adjustable;
at least a first and second adjustable support mechanism associated with the first and second side impact sections respectively, each adjustable support mechanism configured for adjusting the angle of the respective side impact section and operatively to retain said side impact section at a predetermined angle.

2. The impact bed according to claim 1, wherein each adjustable support mechanism comprises a support arm pivotably fixed to a base and an adjustment mechanism received between the support arm and the base.

3. The impact bed according to claim 2, wherein each side impact section is fixed relative to the support arm of the respective adjustable support mechanism associated with it.

4. The impact bed according to claim 2, wherein the adjustment mechanism comprises a pivotably interconnected upper and lower support strut configured as a scissor link, opposite end portions of which are pivotably linked to the support arm and base respectively, and an adjustment rod extending between the scissor link and one of the support arm and base.

5. The impact bed according to claim 4, wherein the adjustment rod comprises a threaded rod, lockable and/or adjustable relative to the scissor link by way of a nut.

6. The impact bed according to claim 4, wherein the adjustment rod extends through a bush pivotably supported by the scissor link.

7. The impact bed according to claim 2, wherein the adjustment mechanism comprises an adjustment rod extending between the support arm and the base which is lockable and/or adjustable by way of a nut.

8. The impact bed according to claim 1, wherein each of the impact sections comprises one of: i) or more impact slat or pad; ii) one or more impact bar; iii) one or more impact roller or idler; and iv) one or more impact slider bar.

9. The impact bed according to claim 2, comprising a main support frame, wherein the central impact section is fixed to and/or supported by the main support frame, and wherein the base of each adjustable support mechanism is fixed relative to the main support frame.

10. The impact bed according to claim 1, wherein each side impact section is associated with two adjustable support mechanisms.

11. The impact bed according to claim 1, configured as a loading bed, wherein the central impact section is configured as a central loading section and the side impact sections are configured as side loading sections.

12. The impact bed according to claim 3, wherein the adjustment mechanism comprises a pivotably interconnected upper and lower support strut configured as a scissor link, opposite end portions of which are pivotably linked to the support arm and base respectively, and an adjustment rod extending between the scissor link and one of the support arm and base.

13. The impact bed according to claim 5, wherein the adjustment rod extends through a bush pivotably supported by the scissor link.

14. The impact bed according to claim 3, wherein the adjustment mechanism comprises an adjustment rod extending between the support arm and the base which is lockable and/or adjustable by way of a nut.

15. The impact bed according to claim 2, wherein each of the impact sections comprises one of: i) or more impact slat or pad; ii) one or more impact bar; iii) one or more impact roller or idler; and iv) one or more impact slider bar.

16. The impact bed according to claim 3, wherein each of the impact sections comprises one of: i) or more impact slat or pad; ii) one or more impact bar; iii) one or more impact roller or idler; and iv) one or more impact slider bar.

17. The impact bed according to claim 4, wherein each of the impact sections comprises one of: i) or more impact slat or pad; ii) one or more impact bar, iii) one or more impact roller or idler; and iv) one or more impact slider bar.

18. The impact bed according to claim 5, wherein each of the impact sections comprises one of: i) or more impact slat or pad; ii) one or more impact bar; iii) one or more impact roller or idler; and iv) one or more impact slider bar.

19. The impact bed according to claim 6, wherein each of the impact sections comprises one of: i) or more impact slat or pad; ii) one or more impact bar; iii) one or more impact roller or idler; and iv) one or more impact slider bar.

20. The impact bed according to claim 7, wherein each of the impact sections comprises one of: i) or more impact slat or pad; ii) one or more impact bar; iii) one or more impact roller or idler; and iv) one or more impact slider bar.
